(19) United States
(12) Patent Application Publication
(10) Pub. No.: US 2017/0214589 A1
(43) Pub. Date: Jul. 27, 2017

(54) IDENTIFYING GATEWAY MEMBERS BETWEEN GROUPS IN SOCIAL NETWORKS

(71) Applicant: LinkedIn Corporation, Mountain View, CA (US)

(72) Inventor: Michael Conover, San Francisco, CA (US)

(73) Assignee: LinkedIn Corporation, Mountain View, CA (US)

(21) Appl. No.: 15/008,339

(22) Filed: Jan. 27, 2016

(51) Int. Cl. H04L 12/26; G06F 17/30; H04L 29/08

(52) U.S. Cl. CPC H04L 43/045; H04L 67/10; G06F 17/30958; G06F 17/30979; G06F 17/3053

(57) ABSTRACT

The disclosed embodiments provide a system for facilitating interaction within a social network. During operation, the system obtains a graph of a social network, wherein the graph includes a set of nodes representing members of the social network and a set of edges representing relationships between pairs of the members. Next, the system uses the graph to identify a subset of the members with high betweenness centrality within a subgraph that includes a first group in the social network and a second group in the social network. The system then outputs an indication of high betweenness centrality for the subset of the members to facilitate interaction between the first and second groups.

### BACKGROUND

Field

The disclosed embodiments relate to social networks. More specifically, the disclosed embodiments relate to techniques for identifying gateway members between groups in social networks.

Related Art

Social networks may include nodes representing individuals and/or organizations, along with links between pairs of nodes that represent different types and/or levels of social familiarity between the nodes. For example, two nodes in a social network may be connected as friends, acquaintances, family members, classmates, and/or professional contacts. Social networks may further be tracked and/or maintained on web-based social networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, social networks and/or online professional networks may facilitate business activities such as sales, marketing, and/or recruiting by the individuals and/or organizations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions.

However, people in social networks tend to be clustered into disparate, non-overlapping communities. For example, employees of a company may generally interact within the same functional units or organizations and thus lack exposure to the knowledge or perspective that other functional units or organizations in the company may have. Because information exchange between relatively unconnected communities in a social network is limited, the social capital within the social network may not be fully utilized.

Consequently, use of social networks may be facilitated by mechanisms for increasing interaction among communities with low connectivity in the social networks.

### BRIEF DESCRIPTION OF THE FIGURES

FIG. 1 shows a schematic of a system in accordance with the disclosed embodiments.

FIG. 2 shows a system for facilitating interaction within a social network in accordance with the disclosed embodiments.

FIG. 3 shows a flowchart illustrating the process of facilitating interaction within a social network in accordance with the disclosed embodiments.

FIG. 4 shows a flowchart illustrating the process of identifying a subset of members with a high betweenness centrality in a subgraph containing two groups in a social network in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

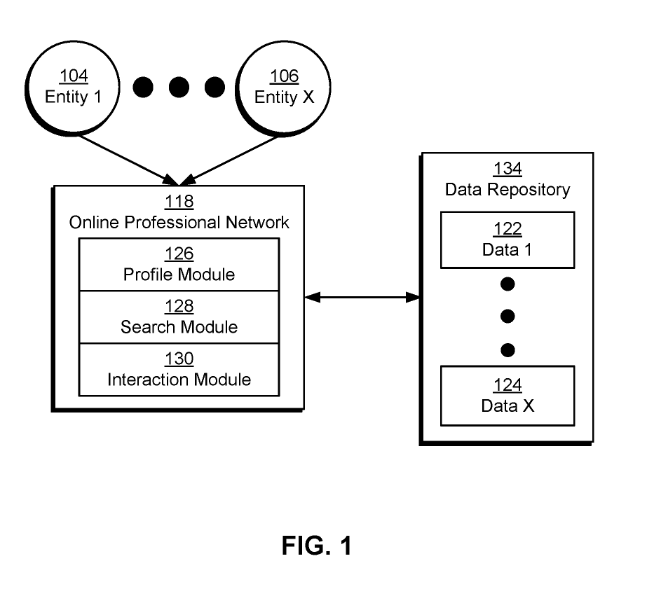

The disclosed embodiments provide a method, system, and apparatus for facilitating interaction within a social network. As shown in FIG. 1, the social network may include an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, experience level, etc.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

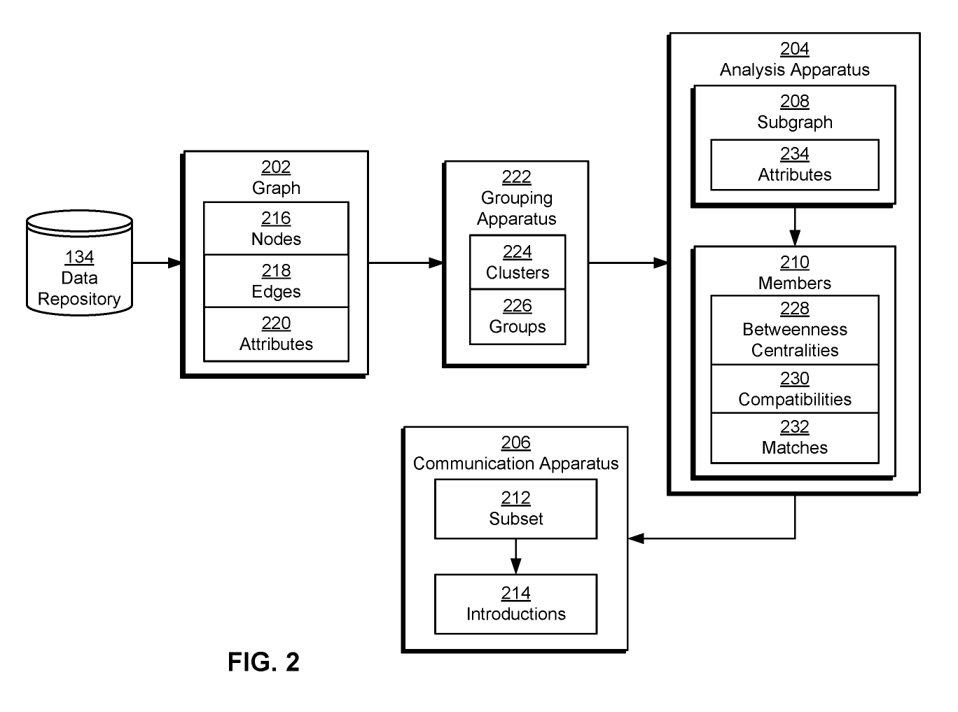

As shown in FIG. 2, data in data repository 134 may be used to form a graph 202 representing the entities, the entities' relationships, and/or the entities' activities in a social network such as online professional network 118 of FIG. 1. Alternatively, graph 202 may be formed from other data, such as proximity data from users connected to cellular towers and/or Wi-Fi access points, and/or publicly accessible records of the entities. Graph 202 may include a set of nodes 216, a set of edges 218, and a set of attributes 220.

Nodes 216 in graph 202 may represent entities in the online professional network. For example, the entities represented by nodes 216 may include individual members (e.g., users) of the online professional network, groups joined by the members, and/or organizations such as schools and companies. Nodes 216 may also represent other objects and/or data in the online professional network, such as industries, locations, posts, articles, multimedia, job listings, ads, and/or messages.

Edges 218 may represent relationships and/or interaction between pairs of nodes 216 in graph 202. For example, edges 218 may be directed and/or undirected edges that specify connections between pairs of members, education of members at schools, employment of members at companies, following of a member or company by another member, business relationships and/or partnerships between organizations, and/or residence of members at locations. Edges 218 may also, or instead, indicate actions taken by entities, such as creating or sharing articles or posts, sending messages, connection requests, joining groups, and/or following other entities.

Nodes 216 and/or edges 218 may contain attributes 220 that describe the corresponding entities, objects, associations, and/or relationships in the online professional network. For example, a node representing a member may include attributes such as name, username, industry, title, seniority, password, and/or email address. Similarly, an edge representing a connection between the member and another member may have attributes such as a time at which the connection was made, the type of connection (e.g., friend, colleague, classmate, employee, following, etc.), and/or a strength of the connection (e.g., how well the members know one another).

A grouping apparatus 222 may use graph 202 to calculate a set of clusters 224 of users in the social network. To calculate clusters 224, grouping apparatus 222 may use a community-detection technique such as modularity maximization technique, hierarchical clustering, label propagation, and/or Louvain fast modularity. Each cluster may thus represent a set of relatively densely connected nodes within graph 202, while nodes from different clusters may be less inter-connected than nodes within each cluster. In turn, users within a given cluster may generally have limited interaction with users from other clusters. For example, employees of a company may be clustered into distinct organizations or functional units, such as engineering, sales, marketing, legal, analytics, and/or product divisions. Clusters 224 may additionally or instead be formed based on location or some other characteristic. For example, sales employees in the company may be more connected to other sales employees in the same country or continent, and less connected to sales employees in different countries or continents.

Grouping apparatus 222 may also identify other groups 226 of users in the social network, independently of or in conjunction with the calculation of clusters 224. For example, grouping apparatus 222 may generate groups 226 of users along one or more attributes 220 such as skills, interests, and/or activities; functional areas representing departments, teams, and/or units within an organization; location or geographic region; or schools, employers, and/or other organizations. Grouping apparatus 222 may match groups 226 to clusters 224 to identify subsets of the social network that are distinct and/or isolated, or grouping apparatus 222 may generate groups 226 and clusters 224 separately.

Such grouping or clustering of users may restrict information exchange within the social network, thus preventing the full utilization of social capital within the social network. For example, employees that interact within functional units of their organization and/or with a limited number of other organizations may lack exposure to the perspective or knowledge of employees from other parts of the company. Such lack of interaction within or across organizations may limit the ability of the employees to innovate, make informed decisions, access resources that may assist with the employees' duties or goals, and/or otherwise perform tasks related to the functioning of the company.

In one or more embodiments, the system of FIG. 2 includes functionality to improve interaction between users in disparate clusters 224 or groups 226 of the social network. First, an analysis apparatus 204 may obtain a subgraph 208 of the social network that contains two distinct clusters 224 or groups 226 of users. For example, analysis apparatus 204 may identify a different subgraph for every pair of clusters 224 and/or groups 226 generated by grouping apparatus 222.

Next, analysis apparatus 204 may obtain a set of members 210 in subgraph 208. For example, subgraph 208 may include two functional areas of an organization. Analysis apparatus 204 may identify members 210 of the subgraph as users of the social network with attributes 220 that place them in one or both functional areas.

After members 210 are identified, analysis apparatus 204 may calculate betweenness centralities 228 of the members using a subset of edges 218 associated with subgraph 208. For example, analysis apparatus 204 may generate a betweenness centrality for each member in subgraph 208 as the number of shortest paths that run through a node representing the member divided by the total number of shortest paths in the subgraph. Analysis apparatus 204 may optionally restrict the calculation of the betweenness centrality to shortest paths between members of one group or cluster in subgraph 208 and members of the other group or cluster in the subgraph. Thus, the betweenness centrality of a given member may represent the ability of the member to “bridge” the two groups or clusters.

Analysis apparatus 204 may then use betweenness centralities 228 to identify a subset 212 of members 210 with high betweenness centrality in subgraph 208. To identify subset 212, analysis apparatus 204 may rank members 210 by the corresponding betweenness centralities 228 and select subset 212 as a pre-specified number of the members with the highest betweenness centralities, a subset of the members with betweenness centralities that exceed a pre-specified numeric threshold, and/or a subset of the members with betweenness centralities that are higher than a percentile rank (e.g., 95^{th} percentile, 99^{th} percentile, etc.).

Analysis apparatus 204 may also determine a set of compatibilities 230 between members in subset 212 and other members in subgraph 208. To determine the compatibility between one member in subset 212 and another member in subgraph 208, analysis apparatus 204 may use attributes 234 of the users from subgraph 208 to calculate a compatibility score between the two members. Attributes for a given member may include, for example, a reputation score (e.g., a measure of the member's reputation in the social network), a skill (e.g., a job-related skill), an interest (e.g., hobby, activity, etc.), a group (e.g., club, professional organization, school organization, etc.), a company (e.g., place of employment), an industry, a location, a position, a seniority, and/or other declared or inferred characteristics of the member. The member's attributes may be used to populate a member vector for the user. For example, the member vector may include a set of skills possessed by the member, one or more employers of the member, one or more schools attended by the user, the member's location, the member's industry, the member's seniority, and the member's reputation score.

To calculate a compatibility score for a pair of members based on attributes 234 of the members, analysis apparatus 204 may combine member vectors for the members into a compatibility vector representing the similarity of the users to one another. Continuing with the above example, the compatibility vector may include the geographic distance between the members, a Boolean value for attendance of the same school, a number of common skills, a number of common employers, an overlap in industries, a difference in the members' levels of seniority, and/or a difference in the members' reputation scores. A set of attribute weights may then be applied to elements of the compatibility vector to obtain a compatibility score for the pair of members. For example, attribute weights may be used to produce the compatibility score as a weighted combination of elements in the compatibility vector. Each attribute weight may represent the relative importance of the corresponding attribute in the compatibility vector. A higher attribute weight may thus increase the contribution of the attribute to the compatibility score, while a lower attribute weight may decrease the contribution of the attribute the compatibility score.

After compatibilities 230 are generated between members in subset 212 and other members of subgraph 208, analysis apparatus 204 may use the compatibilities to produce a set of matches 232 between members in subset 212 and the other members. For example, analysis apparatus 204 may identify a high compatibility between a pair of members when the corresponding compatibility score is one of a pre-specified number of highest compatibility scores in subgraph 208, exceeds a numeric threshold, and/or is higher than a certain percentile of all compatibility scores calculated by analysis apparatus 204. If the high compatibility is found and one of the members in the pair is in subset 212, analysis apparatus 204 may include the pair in matches 232.

A communication apparatus 206 may then output an indication of high betweenness centrality for subset 212 to increase interaction between the two groups or clusters in subgraph 208. For example, communication apparatus 206 may include subset 212 in a list of “gateway members” between the two groups or clusters and display the list to members 210 in one or both groups when the members access the social network. In turn, a member in one group or cluster may use the list to discover contacts that can connect the member with members of the other group or cluster.

Communication apparatus 206 may also generate introductions 214 among pairs of members in matches 232. Each introduction may be performed by transmitting the introduction to the corresponding pair of members. For example, communication apparatus 206 may use email, a messaging service, a “People You May Know” feature, and/or an introduction feature on the social network to communicate the introduction to one or both members. Alternatively, the introduction may be made by scheduling an event to be attended by the first and second members. For example, communication apparatus 206 may access calendars of both users and schedule a lunch or coffee meeting at a time when both users are available.

Communication apparatus 206 may also, or instead, make introductions 214 between a pair of members in two separate groups or clusters of subgraph 208 through a third member with a high betweenness centrality in subgraph 208. For example, communication apparatus 206 may use a messaging service and/or introduction feature in the social network to suggest that the third member introduce the first two members. Before the suggestion is transmitted, analysis apparatus 204 may optionally verify a high compatibility between the first two members and/or a preexisting relationship (e.g., social network connection) between one or both members and the third member. After receiving the suggestion to introduce the other two members, the third member may make the introduction through the messaging service and/or introduction feature, thus establishing initial contact between the first and second members and facilitating subsequent communication and interaction between the first and second members.

Those skilled in the art will appreciate that the system of FIG. 2 may be implemented in a variety of ways. First, analysis apparatus 204, communication apparatus 206, grouping apparatus 222, and/or data repository 134 may be provided by a single physical machine, multiple computer systems, one or more virtual machines, a grid, one or more databases, one or more filesystems, and/or a cloud computing system. Analysis apparatus 204, communication apparatus 206, and grouping apparatus 222 may additionally be implemented together and/or separately by one or more hardware and/or software components and/or layers.

Second, analysis apparatus 204 may use a number of techniques to generate betweenness centralities 228, compatibilities 230, and/or matches 232. As mentioned above, betweenness centralities 228 may be calculated using all shortest paths in subgraph 208 and/or a portion of the shortest paths that connect members of two distinct groups or clusters in the subgraph. Similarly, compatibilities 230 may be calculated from pairs of member vectors using other measures of vector similarity, such as cosine similarity or Jaccard similarity. Analysis apparatus 204 may also, or instead, produce a compatibility score as the absolute value of the difference in the reputation scores or levels of seniority of two members. After betweenness centralities 228 and compatibilities 230 are produced, analysis apparatus 204 may generate a match score as a weighted combination of betweenness centrality and compatibility for each pair of members 210 in subgraph 208. Analysis apparatus 204 may then obtain matches 232 as a subset of the member pairs with match scores that exceed a numeric, percentile, or rank-based threshold.

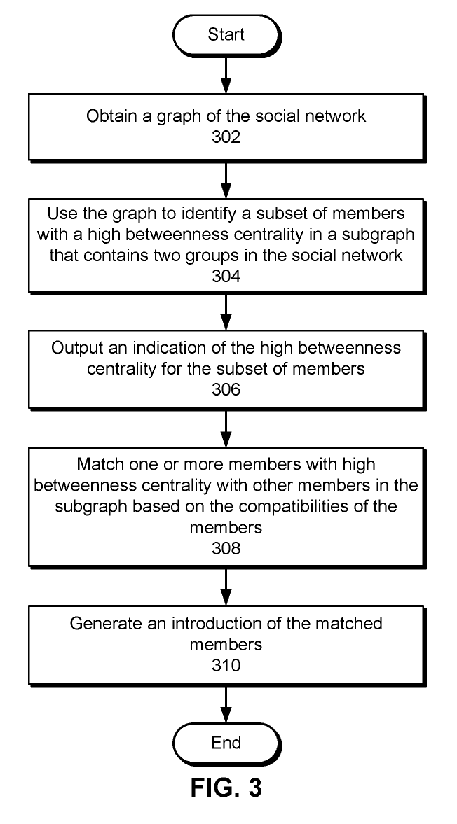

FIG. 3 shows a flowchart illustrating the process of facilitating interaction within a social network in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

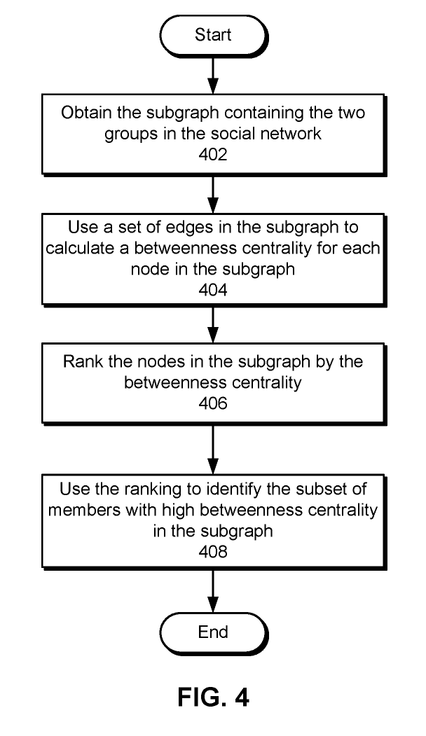

Initially, a graph of the social network is obtained (operation 302). The graph may include a set of nodes representing members of the social network, a set of edges representing relationships between pairs of the members, and a set of attributes associated with the members and/or relationships. Next, the graph is used to identify a subset of the members with a high betweenness centrality in a subgraph of the social network that contains two groups in the social network (operation 304), as described in further detail below with respect to FIG. 4. The groups may be defined according to clusters, functional areas, and/or other attributes associated with the nodes or edges in the graph.

An indication of the high betweenness centrality for the subset of members is then outputted (operation 306). For example, the subset of members may be presented as gateway members between the two groups to facilitate interaction between the two groups. One or more members with high betweenness centrality are also matched with other members in the subgraph based on the compatibilities of the members (operation 308). The compatibilities may be calculated based on attributes of the members. For example, the attributes may include a reputation score, a skill, an interest, a group, a company, an industry, a location, a position, and/or a seniority. A compatibility score may then be calculated based on the similarity of the attributes between a pair of users, and the pair of users may be matched if the compatibility score exceeds a threshold and/or compatibility scores between other pairs of users in the subgraph.

Finally, an introduction of the matched members is generated (operation 310). For example, a message containing the introduction may be transmitted to both members, or an event to be attended by both members may be scheduled or proposed. The introduction may also be generated based on the preferences of one or both members. For example, one or both members may select their preferred methods of being introduced to other members of the social network, and the introduction may be made using some or all of the preferred methods.

FIG. 4 shows a flowchart illustrating the process of identifying a subset of members with a high betweenness centrality in a subgraph containing two groups in a social network in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, the subgraph containing the two groups in the social network is obtained (operation 402). For example, the subgraph may contain members that belong to one or both groups, as well as edges between the members and other members of the subgraph. Next, a set of edges in the subgraph is used to calculate a betweenness centrality for each node in the subgraph (operation 404). For example, the betweenness centrality for a given node may be set to the number or proportion of shortest paths that pass through the node in the subgraph.

The nodes in the subgraph are then ranked by their betweenness centrality (operation 406). For example, the nodes may be ranked in descending order of betweenness centrality. Finally, the ranking is used to identify the subset of members with high betweenness centrality in the subgraph (operation 408). For example, the members with high betweenness centrality may be obtained by applying a numeric threshold to the values of betweenness centrality for the nodes, selecting a pre-specified number of the top-ranked nodes, and/or selecting a pre-specified number of nodes with betweenness centralities that are higher than a certain percentile of all betweenness centralities in the subgraph.

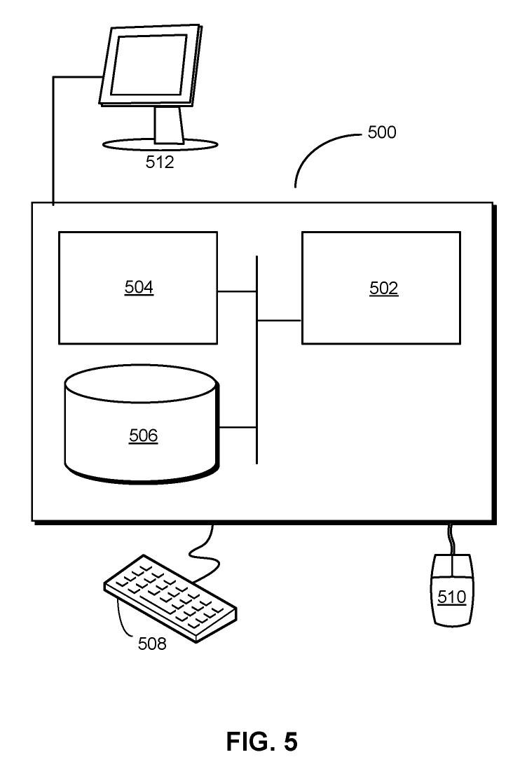

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for increasing interaction within a social network. The system may include a grouping apparatus that identifies a set of clusters or groups in a graph of the social network. The system may also include an analysis apparatus that uses a graph of the social network to identify a subset of the members with a high betweenness centrality for a subgraph that contains a first group in the social network and a second group in the social network. The system may further include a communication apparatus that outputs an indication of the high betweenness centrality for the subset of the members to facilitate interaction between the first and second groups.

In addition, one or more components of computer system 500 may be remotely located and connected to the other components over a network. Portions of the present embodiments (e.g., analysis apparatus, communication apparatus, grouping apparatus, etc.) may also be located on different nodes of a distributed system that implements the embodiments. For example, the present embodiments may be implemented using a cloud computing system that increases interaction among a set of remote users in two groups of a social network by introducing pairs of the users according to the betweenness centralities of the users within a subset of the social network that contains the two groups.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a graph of a social network, wherein the graph comprises:
a set of nodes representing members of the social network; and
a set of edges representing relationships between pairs of the members;
using the graph to identify, by one or more computer systems, a subset of the members with high betweenness centrality in a subgraph that comprises a first group in the social network and a second group in the social network; and
outputting an indication of high betweenness centrality for the subset of the members to facilitate interaction between the first and second groups.

2. The method of claim 1, wherein identifying the subset of the members with high betweenness centrality in the subgraph comprises:
obtaining the subgraph comprising the first and second groups in the social network;
using a subset of the edges in the subgraph to calculate a betweenness centrality for each node in the subgraph;
ranking a subset of the nodes in the subgraph by their betweenness centrality; and
using the ranking to identify the subset of the members with high betweenness centrality in the subgraph.

3. The method of claim 1, further comprising:
matching a first member with high betweenness centrality with a second member in the subgraph based on a compatibility between the first and second members.

4. The method of claim 3, wherein the compatibility is identified using a first set of attributes for the first member and a second set of attributes for the second member.

5. The method of claim 4, wherein the first and second sets of attributes comprise at least one of:
a reputation score;
a skill;
an interest;
a group;
a company;
an industry;
a location;
a position; and
a seniority.

6. The method of claim 1, wherein outputting the indication of high betweenness centrality for the subset of the members comprises:
presenting the subset of the members as gateway members between the first and second groups.

7. The method of claim 1, wherein outputting the indication of high betweenness centrality for the subset of the members comprises:
generating an introduction of a first member with high betweenness centrality and a second member in the subgraph.

8. The method of claim 1, wherein the first and second groups are associated with different functional areas in the social network.

9. The method of claim 1, wherein the first and second groups are associated with different clusters in the social network.

10. The method of claim 1, wherein:
the set of members includes a set of companies, and
the set of edges represent at least one of:
an employment of a member at a company;
a connection of the member to another member; and
a following of the member or the company by the other member.

11. An apparatus, comprising:
one or more processors; and
memory storing instructions that, when executed by the one or more processors, cause the apparatus to:
obtain a graph of a social network, wherein the graph comprises:
a set of nodes representing members of the social network; and
a set of edges representing relationships between pairs of the members;
use the graph to identify a subset of the members with high betweenness centrality for a subgraph that comprises a first group in the social network and a second group in the social network; and
output an indication of high betweenness centrality for the subset of the members to facilitate interaction between the first and second groups.

12. The apparatus of claim 11, wherein identifying the subset of the members with high betweenness centrality in the subgraph comprises:
obtaining the subgraph comprising the first and second groups in the social network;
using a subset of the edges in the subgraph to calculate a betweenness centrality for each node in the subgraph;
ranking a subset of the nodes in the subgraph by their betweenness centrality; and
using the ranking to identify the subset of the members with high betweenness centrality.

13. The apparatus of claim 11, wherein the memory further stores instructions that, when executed by the one or more processors, cause the apparatus to:
match a first member with high betweenness centrality with a second member in the subgraph based on a compatibility between the first and second members.

14. The apparatus of claim 13, wherein the compatibility is identified using a first set of attributes for the first member and a second set of attributes for the second member.

15. The apparatus of claim 14, wherein the first and second sets of attributes comprise at least one of:
a reputation score;
a skill;
an interest;
a group;
a company;
an industry;
a location;
a position; and
a seniority.

16. The apparatus of claim 11, wherein outputting the indication of high betweenness centrality for the subset of the members comprises:
presenting the subset of the members as gateway members between the first and second groups.

17. The apparatus of claim 11, wherein outputting the indication of high betweenness centrality for the subset of the members comprises:
generating an introduction of a first member with high betweenness centrality and a second member in the subgraph.

18. The apparatus of claim 11, wherein the first and second groups are associated with at least one of:
different functional areas in the social network; and
different clusters in the social network.

19. A system, comprising:
an analysis module comprising a non-transitory computer-readable medium comprising instructions that, when executed, cause the system to:
obtain a graph of a social network, wherein the graph comprises:
a set of nodes representing members of the social network; and
a set of edges representing relationships between pairs of the members; and
use the graph to identify a subset of the members with high betweenness centrality for a subgraph that comprises a first group in the social network and a second group in the social network; and
a communication module comprising a non-transitory computer-readable medium comprising instructions that, when executed, cause the system to output an indication of high betweenness centrality for the subset of the members to facilitate interaction between the first and second groups.

20. The apparatus of claim 19, wherein identifying the subset of the members with high betweenness centrality in the subgraph comprises:
obtaining the subgraph comprising the first and second groups in the social networks;
using a subset of the edges in the subgraph to calculate a betweenness centrality for each node in the subgraph;
ranking a subset of the nodes in the subgraph by their betweenness centrality; and
using the ranking to identify the subset of the members with high betweenness centrality.
